(19) United States
(12) Patent Application Publication
(10) Pub. No.: US 2011/0252916 A1
(43) Pub. Date: Oct. 20, 2011

(54) Sensor device for measuring torque in steering systems

(76) Inventor: Wolfgang Abele, Spraitbach (DE)

(21) Appl. No.: 13/068,389

(22) Filed: May 10, 2011

Related U.S. Application Data
(63) Continuation of application No. PCT/EP2009/065452, filed on Nov. 19, 2009.

(30) Foreign Application Priority Data
Nov. 25, 2008 (DE) 10 2008 044 059.0

(51) Int. Cl. B62D 1/02; G01L 3/10

(52) U.S. Cl. 74/491; 73/862.325

(57) ABSTRACT

A sensor device for measuring torque in steering systems of vehicles comprises a magnet that is disposed on a shaft in a rotationally fixed manner, and a magnetic field sensor. The magnet is held by a magnet holder, which is to be connected to the shaft, wherein the magnet holder comprises a receiving region disposed at a radial distance from the shaft and the magnet is disposed on the inside of the receiving region facing the shaft.

This is a Continuation Application of PCT/EP2009/065452 filed Nov. 19, 2009.

### BACKGROUND OF THE INVENTION

The invention relates to a sensor device for measuring torque in steering systems of vehicles.

DE 101 27 169 B4 describes a steering system for a motor vehicle, which is equipped with an electric servomotor for steering assistance. Establishing the amount of the assistance torque requires knowledge of the torque presently acting on the steering shaft, which is determined by means of a sensor device.

Sensor devices for measuring torque used in steering systems are typically magnet-based systems, which comprise a magnet that is disposed on the shaft in a rotationally fixed manner and a magnetic field sensor that is fixed to the housing or connected to a second part of the shaft in a rotationally fixed manner and is able to detect a change in the magnetic field during relative rotation. For example, Hall sensors or MR sensors are sensors that are used. On the shaft side, magnetic rings having a plurality of poles are used, which are seated on the shaft either directly or by means of a carrier ring, with the sensor generally being positioned at a radial distance outward of the magnet.

There is a trend toward using increasingly rigid shafts in steering systems, but in terms of torque measurement this creates a problem in that the shaft produces lower torsion at a particular torque, and thus the change in the magnetic field detected by the magnetic field sensor is also lower. The signal supplied by the sensor is accordingly less accurate.

### SUMMARY OF THE INVENTION

It is an object of the invention to refine a sensor device for capturing torque in steering systems of vehicles, using simple design measures, so that the torque signal generated is as accurate as possible, with a compact design.

The sensor device according to the invention is used to measure torque in the steering systems of vehicles, in particular for determining the manual steering torque predefined by the driver via the steering wheel. The steering system is preferably equipped with an electric drive motor for servo assistance, but hydraulic or electrohydraulic servo assistance is also generally possible.

The sensor device comprises a magnet that is disposed on a shaft of the steering system in a rotationally fixed manner and a magnetic field sensor, which, in relation to the magnet, is either disposed on a second section of the shaft with respect to which the shaft section carrying the magnet performs a relative rotary motion, or fixed to the housing. The magnet is carried by a magnet holder, which is connected to the shaft. During the relative rotary motion between the magnet and magnetic field sensor, the sensor detects a change in the magnetic field originating from the magnet, this change being a measure of the relative rotation, and hence the acting torque.

According to the invention, the magnet holder carrying the magnet comprises a receiving region disposed at a radial distance from the shaft, and the magnet is disposed on the inside of the receiving region facing the shaft. This constitutes a departure from prior art designs, in terms of the arrangement of the magnet in relation to the shaft or the magnet holder. With the design according to the invention, the magnet is located on the inside of the receiving region in the magnet holder and faces the shaft, while in designs according to the prior art the magnet is disposed at the exterior of the magnet holder and is directed radially outward. Compared to the prior art, the novel arrangement according to the invention has the advantage that the magnet is at a relatively large radial distance from the shaft, despite the compactness overall design, so that angular changes of the shaft result in a relatively large travel of the magnet, and thus a significant change in the magnetic field can be detected, which positively affects the quality of the measurement signal.

According to a preferred embodiment, in addition, the magnetic field sensor is at a radial distance, with respect to the rotational axis of the shaft, that is no greater than that of the magnet, whereby a compact design can also be achieved in the radial direction. To this end, the magnetic field sensor is either seated radially in the interposed region between the exterior of the shaft and the magnet, so that the sensor is shielded to the radial exterior by the magnet, or the magnetic field sensor is located at an axial distance from the axial end face of the magnet. In both cases, the sensor is located within the radius that is determined by the exterior of the magnet. Disposing the sensor between the exterior of the shaft and the magnet is also advantageous in that a very compact design is further achieved in the axial direction, because it is generally unnecessary for the sensor to protrude axially beyond the magnet.

Because of the optimized arrangement, a signal improvement of roughly up to 50% is achieved with the same installation space size. Conversely, it is also possible to achieve a significant reduction in the installation space with the same signal quality.

According to an advantageous embodiment, the magnet has a segment-shaped configuration, notably in a rectangular shape or shaped as a circular segment, so that ring-shaped magnets are no longer required. Nonetheless, it may be advantageous to provide a ring-shaped magnet.

The magnet holder is advantageously placed with a ring on the shaft and connected, for example by pressing, to this shaft. It may be advantageous to provide a metal sleeve, which is connected to the magnet holder, by means of which the magnet holder is connected to the shaft. According to a further advantageous embodiment, the magnet holder is implemented as a injection-molded synthetic material part and, in the case of a magnet sleeve, encapsulated by the material of the magnet holder. The magnet holder is connected to the shaft by way of swaging or a press fit connection, optionally by means of the metal sleeve. In principle, however, gluing or joining using mechanical fastening means is also possible.

Notably in combination with a segment-shaped magnet, it is advantageous to design the receiving region of the magnet holder carrying the magnet in a trapezoidal shape, with the narrow side of the trapezoid being located on the radial exterior and the wide side being located adjacent to the shaft.

According to a further preferred embodiment, the magnetic field sensor is rigidly connected to a housing component coupled to the second shaft section, in relation to which the first shaft section performs a relative rotary motion when torque is applied. This housing is notably a spiral spring housing for receiving a spiral spring.

It is also advantageous to dispose the magnetic field sensor on a circuit board, which notably has a rectangular shape and moreover carries further electronic elements and optionally comprises additional contact sites for power supply and/or for software connections. Such circuit boards or circuit cards can be produced in a cost-effective manner.

Further advantages and advantageous embodiments are disclosed in the description of the figure, and the drawings.

### BRIEF DESCRIPTION OF THE DRAWINGS

FIG. 1 is an end face view of a sensor device on a shaft for torque measurement,

FIG. 2 is the sensor device of FIG. 1 in a partially cut away side view,

FIG. 3 is a further embodiment of a sensor device on a shaft, and

FIG. 4 is a side view of the embodiment of FIG. 3.

### DESCRIPTION OF THE PREFERRED EMBODIMENTS

In the figures, identical components are denoted by the identical reference numerals.

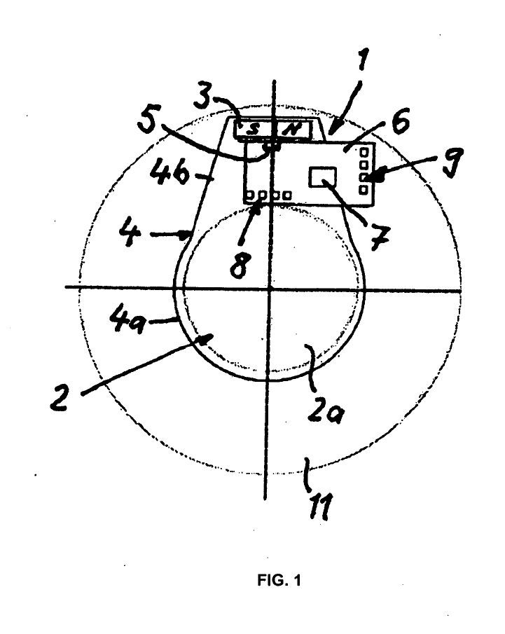

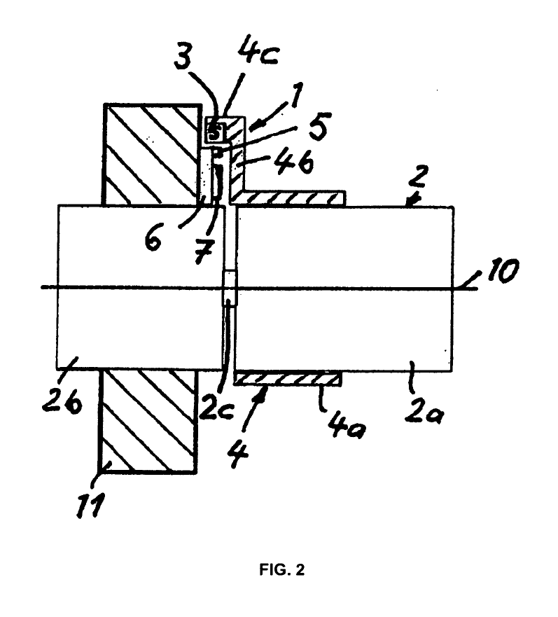

FIGS. 1 and 2 show a first embodiment. According to this embodiment, a sensor device 1 is provided for detecting the torque acting in a shaft 2, wherein the shaft 2 comprises an input shaft 2a, an output shaft 2b and a connecting torsion bar 2c. The torque to be measured acts between the input and output shafts 2a and 2b, which results in torsion in the torsion bar 2c. The torsion is determined by means of the torque sensor device 1 as a measure of the effective torque.

The sensor device 1 comprises a segment-shaped dipole magnet 3, which is rigidly connected to the input shaft 2 by way of a magnet holder 4. The N and S poles of the magnet 3 are located opposite of each other, radially or in the circumferential direction. In addition, the sensor device 1 comprises a magnetic field sensor 5, which is able to detect changes in the magnetic field originating from the magnet 3, which result from relative rotation between the input shaft 2a and output shaft 2b. The magnetic field sensor 5 is configured, for example, as a Hall sensor or as an AMR sensor, which is based on the anisotropic magnetoresistive effect.

The sensor 5 is seated on a rectangular circuit board 6, which additionally carries further electronic components 7, and notably ASICS. Moreover, the circuit board 6 is provided with an electric contact point 8, by means of which an electric winding tape can notably be connected, and a software or programming interface 9.

The magnet holder 4 on which the magnet 3 is disposed comprises a ring 4a, which is pushed onto the input shaft 2a, and a trapezoidal receiving region 4b, at the radially exterior side of which the magnet 3 is held. As is apparent from FIG. 2, an axially protruding carrier section 4c is designed to be integral with the receiving region 4b of the magnet holder 4 in the region of the radially exterior side of the magnet holder, wherein the magnet 3 is disposed on the inside of the carrier section 4c. In this way, maximum radial distance between the magnet 3 and the shaft 2, or the rotational axis 10 of the shaft, can be implemented. The magnet holder 4 is in particular configured as an injection-molded synthetic material component and is rigidly connected to the input shaft 2a, a metal sleeve being optionally provided for connecting to the shaft, with the sleeve being molded into the material of the magnet holder.

The magnetic field sensor 5 is located in the radially interposed region between the magnet 3 and the exterior of the shaft 2. In this way, the magnetic field sensor 5 is radially covered by the magnet 3 and the carrier section 4 carrying the magnet 3, which is embedded into the material of the magnet holder, notably during the injection molding process. The sensor 5 is located, firstly, radially beneath the magnet 3, and secondly, axially within the region covered by the magnet 3 and the carrier section 4c.

The circuit board 6 comprising the elements disposed thereon, including the magnetic field sensor 5, is held on a spiral spring housing 11, which is rigidly connected to the output shaft 2.

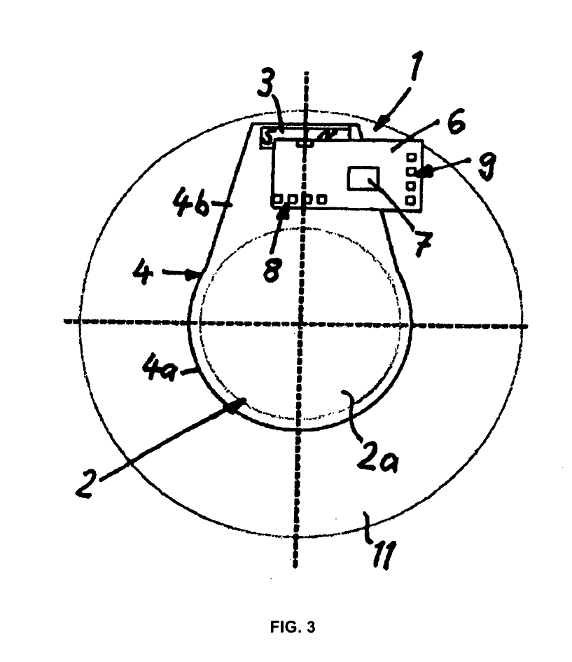

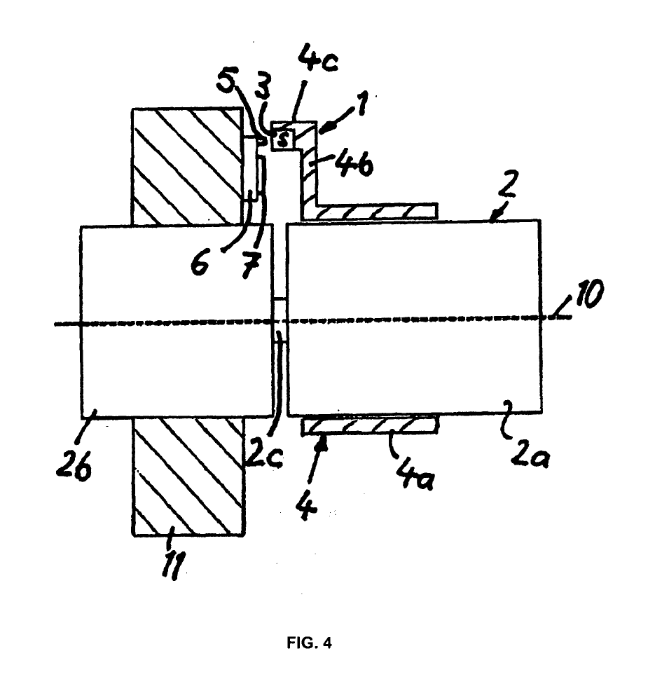

In the embodiment according to FIGS. 3 and 4, the basic design is identical to that of FIGS. 1 and 2, and thus reference is made to the foregoing description. However, the relative positioning of the magnetic field sensor 5 in relation to the magnet 3 is different. In the embodiment according to FIGS. 3 and 4, the magnetic field sensor 5 is disposed axially in front of the magnet 3 and therefore is not shielded radially outwardly by the magnet 3 or the carrier section 4c. The magnet 3 is accordingly magnetized at the end face side. In this design as well, the radial distance between the magnetic field sensor 5 and the shaft 2 or the rotational axis 10 is no greater than the radial distance of the magnet 3, and in particular of the outer carrier section 4c, with respect to the shaft 2, or the rotational axis 10.

### LIST OF REFERENCE NUMERALS

1 Sensor device
2 Shaft
2a Input shaft
2b Output shaft
2c Torsion bar
3 Magnet
4 Magnet holder
4a Ring
4b Receiving region
4c Carrier section
5 Magnetic field sensor
6 Circuit board
7 Electrical elements
8 Contact point
9 Programming interface
10 Rotational axis
11 Spiral spring housing

1. A sensor device for measuring torque in steering systems of vehicles, comprising a magnet that is disposed on a shaft in a rotationally fixed manner, and a magnetic field sensor, wherein the magnet is held by a magnet holder, which is to be connected to the shaft, with the magnet holder comprising a receiving region disposed at a radial distance from the shaft, the magnet being disposed on the inside of the receiving region facing the shaft, and with the radial distance of the magnet from the shaft being greater than the radial distance of the magnetic field sensor from the shaft.

2. (canceled)

3. The sensor device according to claim 1, wherein the magnetic field sensor is positioned radially between the shaft and the magnet.

4. (canceled)

5. A sensor device according to that claim 1, wherein the magnet has a segment-shaped design.

6. A sensor device according to claim 1, wherein the magnet holder is placed on the shaft.

7. A sensor device according to claim 1, wherein the receiving region of the magnet holder comprises an axially protruding carrier section on an inside of which the magnet is held facing the shaft.

8. The sensor device according to claim 7, wherein the carrier section covers the magnetic field sensor radially outwardly.

9. A sensor device according to claim 1, wherein the receiving region of the magnet holder has a trapezoidal design.

10. A sensor device according to claim 1, wherein the magnet holder is configured as a injection-molded synthetic material component.

11. A sensor device according to claim 1, wherein the magnetic field sensor is held on a spiral spring housing.

12. A sensor device according to claim 1, wherein the magnetic field sensor is seated on a rectangular circuit board which also carries electronic elements.

13. A steering system in a vehicle, comprising a sensor device for measuring torque according to claim 1.

14. A sensor device according to claim 3, wherein the magnet has a segment-shaped design.

15. A sensor device according to claim 3, wherein the magnet holder is placed on the shaft.

16. A sensor device according to claim 5, wherein the magnet holder is placed on the shaft.

17. A sensor device according to claim 3, wherein the receiving region of the magnet holder comprises an axially protruding carrier section on an inside of which the magnet is held facing the shaft.

18. A sensor device according to claim 5, wherein the receiving region of the magnet holder comprises an axially protruding carrier section on an inside of which the magnet is held facing the shaft.

19. A sensor device according to claim 6, wherein the receiving region of the magnet holder comprises an axially protruding carrier section on an inside of which the magnet is held facing the shaft.

20. A sensor device according to claim 3, wherein the receiving region of the magnet holder has a trapezoidal design.

21. A sensor device according to claim 5, wherein the receiving region of the magnet holder has a trapezoidal design.

22. A sensor device according to claim 6, wherein the receiving region of the magnet holder has a trapezoidal design.
